(19) United States
(12) Patent Application Publication
(10) Pub. No.: US 2015/0312969 A1
(43) Pub. Date: Oct. 29, 2015

(54) A FOOD PREPARATION APPLIANCE OPERATED ON AN INDUCTION HEATING COOKTOP

(71) Applicant: ARCELIK ANONIM SIRKETI, Istanbul (TR)

(72) Inventors: Sefa HAZIR, Istanbul (TR); Onur YAMAN, Istanbul (TR); Ahmet YORUKOGLU, Istanbul (TR); Ahmet SOZEN, Istanbul (TR)

(21) Appl. No.: 14/442,956

(22) PCT Filed: Oct. 30, 2013
(86) PCT No.: PCT/EP2013/072701

§ 371 Date: May 14, 2015

(30) Foreign Application Priority Data
Nov. 14, 2012 (TR) A 2012/13167

(51) Int. Cl. H05B 6/12; A47J 43/08; H05B 6/44; H05B 6/06; H05B 6/36

(52) U.S. Cl. CPC H05B 6/1236; H05B 6/062; H05B 6/365; H05B 6/44; A47J 43/082

(57) ABSTRACT

The present invention relates to a food preparation appliance (1) suitable to be operated wirelessly on an induction heating cooktop (16) having one or more than one induction coil (17), comprising a ferromagnetic base (2) enabling the appliance (1) to be heated with the magnetic energy transmitted by the induction coil (17), one or more than one receiver coil (3) integrated with the base (2), that partially receives the power generated by the induction coil (17), a cooking pot (4) wherein food cooking and/or mixing operations are performed, a hollow lid (5) that is closed over the cooking pot (4) and a control unit (6) that provides the controlling and monitoring of the operating parameters such as the cooking temperature, cooking duration, mixing speed, etc.

The present invention relates to a food preparation appliance operated wirelessly on an induction heating cooktop and that is heated from its base.

On food preparation appliances operated on the induction heating cooktop with the principle of wireless power transfer, there are communication means that provide communication with the induction heating cooktop such as RF, WIFI, infrared (IRDA), user interfaces that allow parameters such as temperature, motor speed, etc. to be monitored and adjusted, sensors that detect parameters such as temperature and a control unit that regulates the operation of all electronic components, all together giving “smart” features to the said appliances. Low level electrical power is required for energizing the control unit. This electrical power is supplied from the induction coil in the induction heating cooktop by means of a receiver coil integrated with the base of the food preparation appliance. The receiver coil partially receives energy from the induction coil and energizes the control unit, the user interface and the communication means. Thus, the user can perform monitoring and adjustment operations on the food preparation appliance, communication is maintained with the induction heating cooktop and the induction heating cooktop is enabled to transfer power in the desired amount. The control unit and other electronic components of the food preparation appliance are affected by high temperatures during cooking and problems arise while transferring energy from the receiver coil to the control unit. Moreover, the said electronic components prevent performing cleaning operation after preparing the food.

The International Patent Application No. WO9941950 relates to a cooking vessel that is used in induction heating cooktops.

The International Patent Application No. WO2010080738 relates to a smart cookware that is wirelessly operated with an inductive power supply.

In the Japanese Patent Application No. JP9115660, an induction heating cooking appliance is explained wherein the foods contained therein are automatically agitated, preventing burning or heating irregularly.

The aim of the present invention is the realization of a food preparation appliance that is operated wirelessly on the induction heating cooktop, that can be easily cleaned and of which the electronic components such as the control circuit, etc. are protected against heat.

The food preparation appliance (will be referred to as “appliance” hereinafter) realized in order to attain the aim of the present invention, explicated in the first claim and the respective claims thereof, is an appliance such as pot with a mixer motor, etc., operated wirelessly on an induction heating cooktop (will be referred to as “cooktop” hereinafter).

The appliance comprises a cooking pot wherein operations of cooking, mixing, blending and chopping are performed, and a hollow lid that is closed thereon.

The appliance furthermore comprises a ferromagnetic base enabling the appliance to be heated with the magnetic energy transmitted by the induction coil of the cooktop whereon the appliance is operated and one or more than one receiver coil that is integrated with the base, that at least partially receives the power generated by the induction coil and that energizes the electronic components such as the control unit, the user interface, the communication means, etc.

In the appliance of the present invention, the control unit is placed into the lid on the cooking pot and the energy provided by the receiver coil is transmitted to the control unit by means of a connector composed of a plug situated on the cooking top and a socket situated on the lid.

In an embodiment of the present invention, the appliance comprises a mixer motor that is situated inside the lid, that is connected to the control unit, that receives electrical power from the receiver coil by means of the connector and that mixes, blends or chops foodstuffs in the cooking pot in accordance with the user preferences, and furthermore comprises a mixing or chopping apparatus such as paddle or blade, connected to the mixer motor.

In another embodiment of the present invention, the appliance comprises sensors, for example a temperature sensor, that detect parameters such as temperature, level, overflowing and saltiness for the regulation of the cooking process, and the information detected by the sensors are transmitted to the control unit by means of the connector.

In another embodiment of the present invention, the user interface is situated on the lid.

In another embodiment of the present invention, the communication means, that provide communication with the cooktop according to the cooking (temperature) or mixing (mixer motor speed) settings and that enable the cooktop to transmit power at the desired level, are situated inside the lid or on the lid.

In another embodiment of the present invention, a voltage regulating circuit, that enables the control unit, the user interface and the communication means to be supplied with a constant, uninterrupted DC voltage, is situated inside the lid.

In another embodiment of the present invention, two receiver coils are used in the appliance, one for the mixer motor and one for the control unit, the communication means and the user interface.

In another embodiment of the present invention, a separator is placed between the cooking pot and the lid, and the electronic components in the lid are protected against splattering liquids and vapor. The separator serves as a centering apparatus by means of centering holes thereon for connecting the connector and the mixer motor shaft while the lid is being placed onto the cooking top.

In another embodiment of the present invention, an opening is arranged on the lid, and an exhaust apparatus situated on the separator extends to the upper side of the lid by passing through the opening and provides discharge of the vapor during cooking process.

The lid of the appliance of the present invention serves as an electronic control module that can be attached to/detached from the cooking top and wherein all electronic components are located. The electronic components in the lid are protected against high temperature in the cooking top and the cooking pot can be easily cleaned.

The appliance realized in order to attain the aim of the present invention is illustrated in the attached figures, where:

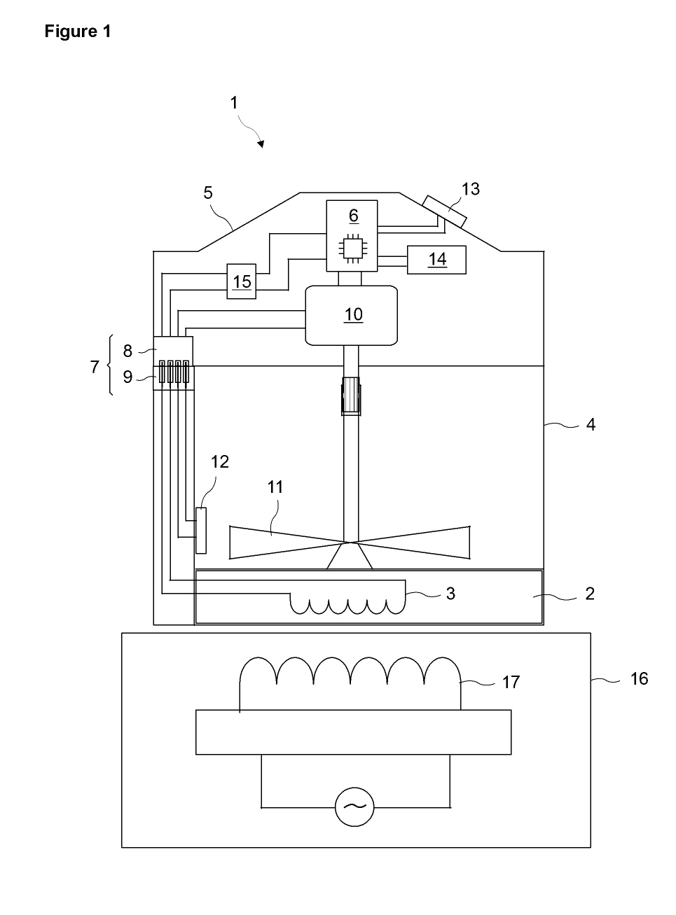

FIG. 1—is the schematic view of the appliance operated on an induction heating cooktop when the lid is closed thereon.

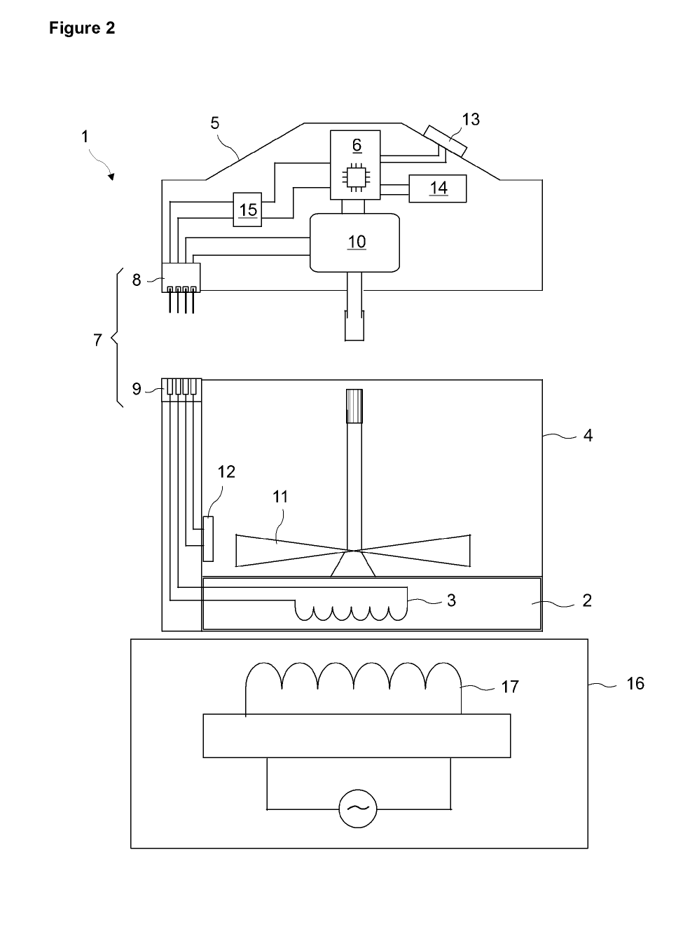

FIG. 2—is the schematic view of the appliance operated on an induction heating cooktop when the lid thereon is removed.

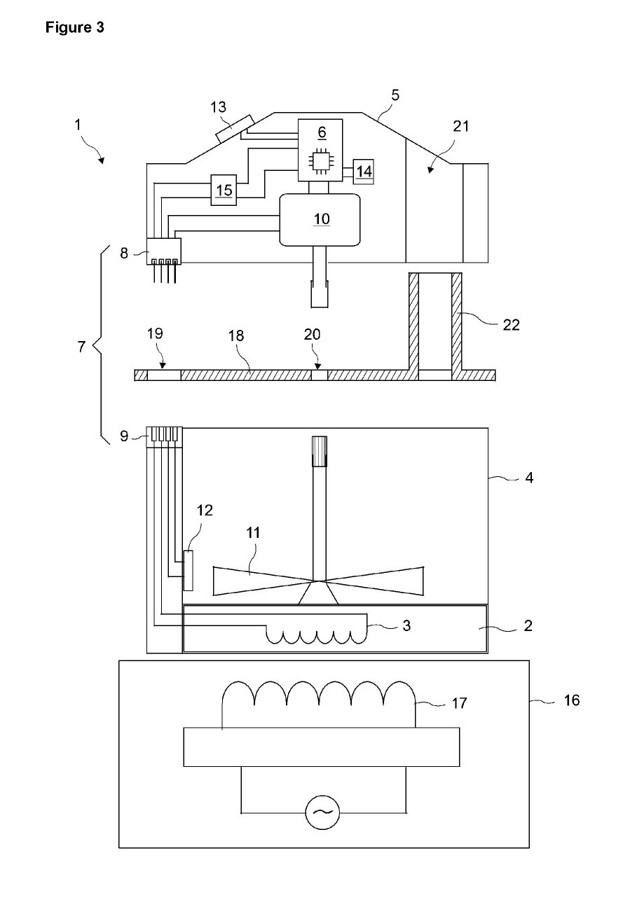

FIG. 3—is the schematic view of the appliance operated on an induction heating cooktop when the lid thereon is removed in another embodiment of the present invention.

The elements illustrated in the figures are numbered as follows:
1. Appliance
2. Base
3. Receiver coil
4. Cooking pot
5. Lid
6. Control unit
7. Connector
8. Socket
9. Plug
10. Mixer motor
11. Mixing or chopping apparatus
12. Sensor
13. User interface
14. Communication means
15. Voltage regulating circuit
16. Cooktop
17. Induction coil
18. Separator
19. Side centering hole
20. Medial centering hole
21. Opening
22. Exhaust apparatus

The food preparation appliance (1) (will be referred to as “appliance (1)” hereinafter) suitable to be operated wirelessly on an induction heating cooktop (16) having one or more than one induction coil (17), comprises a ferromagnetic base (2) enabling the appliance (1) to be heated with the magnetic energy transmitted by the induction coil (17), one or more than one receiver coil (3) integrated with the base (2), that partially receives the power generated by the induction coil (17), a cooking pot (4) wherein food cooking and/or mixing operations are performed, a hollow lid (5) that is closed over the cooking pot (4) and a control unit (6) having a microcontroller that provides the controlling and monitoring of the operating parameters such as the cooking temperature, cooking duration, mixing speed, etc.

The appliance (1) of the present invention comprises the control unit (6) encapsulated by the lid (5) and one or more than one connector (7) that provides the energy transmission from the receiver coil (3) to the control unit (6) when the lid (5) is placed onto the cooking pot (4).

The control unit (6) is placed into the lid (5) and the electrical power required for the control unit (6) is provided from the receiver coil (3). When the lid (5) is placed onto the cooking pot (4), the electrical connection between the receiver coil (3) and the control unit (6) is provided by means of the connector (7), and when the lid (5) is removed from over the cooking pot (4), the electrical connection between the receiver coil (3) and the control unit (6) is interrupted.

In an embodiment of the present invention, the connector (7) comprises a socket (8) that is situated on the lid (5) and electrically connected to the control unit (6) by means of cables, and a plug (9) that is situated on the cooking pot (4) and electrically connected to the receiver coil (3) by means of cables.

In another embodiment of the present invention, the socket (8) is situated at the lower edge of the lid (5) and the plug (9) is situated at the upper edge of the cooking pot (4).

When the lid (5) is placed onto the cooking pot (4), an electrical connection is provided between the receiver coil (3) and the control unit (6) and the electrical power required for the microcontroller is transmitted to the control unit (6) via the induction coil (17)—the receiver coil (3)—the connector (7), in other words energy is transmitted from the cooking pot (4) to the lid (5) (FIG. 1). When the lid (5) is taken off from the cooking pot (4), the socket (8) leaves the plug (9) and the energy transmission between the cooking pot (4) and the lid (5) is interrupted (FIG. 2).

In an embodiment of the present invention, the appliance (1) has food processor features, and comprises a mixer motor (10) that is situated inside the lid (5), that is connected to the control unit (6), to which electrical power is transmitted from the receiver coil (3) by means of the connector (7) and that mixes, blends, chops or grinds the foods in the cooking pot (4) in accordance with the user preferences, and furthermore comprises a mixing or chopping apparatus (11) such as paddle or blade, connected to the mixer motor (10).

The mixer motor (10) is of variable speed type and can be operated at different speeds for mixing, blending or chopping processes in accordance with the user preferences.

In another embodiment of the present invention, the appliance (1) comprises one or more than one sensor (12) placed at the cooking pot (4) and detecting parameters such as temperature, level, overflowing, saltiness, etc. Signals (data) related to the parameters detected by the sensors (12) are transmitted to the control unit (6) by means of the connector (7).

In another embodiment of the present invention, the appliance (1) comprises a user interface (13) that is situated on the lid (5), that is connected to the control unit (6), that receives electrical power from the receiver coil (3) by means of the connector (7) and that has a display and a keypad that provide monitoring and controlling of the operating parameters. Parameters such as temperature, cooking duration, speed of the mixer motor (10) are adjusted and monitored on the lid (5) via the user interface (13).

In another embodiment of the present invention, the appliance (1) comprises one or more than one communication means (14) such as RF, WIFI, etc., that is situated inside or on the lid (5), that is connected to the control unit (6), that receives electrical power from the receiver coil (3) by means of the connector (7) and that provides communication with the cooktop (16). The communication between the appliance (1) and the cooktop (16) is provided, data entries via the keypad on the user interface (13) and the control unit (6) commands related to the data transmitted by the sensors (12) are transmitted to the cooktop (16) by means of the communication means (14), and the induction coil (17) is enabled to transmit power at the required level.

In another embodiment of the present invention, the appliance (1) comprises a voltage regulating circuit (15) that enables the control unit (6), the user interface (13) and the communication means (14) to be supplied with a constant, uninterrupted, low level, such as 5-15V, DC voltage with the power partially received from the induction coil (17) by the receiver coil (3), and that also prevents the said components from being damaged. The voltage regulating circuit (15) is situated inside the lid (5) and the electrical power received from the receiver coil (3) by means of the connector (7) is transmitted to the control unit (6) via the voltage regulating circuit (15).

While the appliance (1) is operated on the cooktop (16), first the power adjustment button (not shown in the figures) on the cooktop (16) is brought to any adjustment position, for example the lowest level (position “0” or “1”) and magnetic energy is transferred from the induction coil (17) to the receiver coil (3). The power received by the receiver coil (3) from the induction coil (17) is transmitted to the control unit (6) in the lid (5) by means of the connector (7). The voltage regulating circuit (15) enables the control unit (6), the user interface (13) and the communication means (14) to be supplied with uninterrupted, constant and low level voltage. According to the operating parameters entered via the user interface (13) and the data sent by the sensors (12), the communication means (14) sends signals to the cooktop (16) and the power transferred from the induction coil (17) to the appliance (1) is adjusted. By means of the user interface (13), the cooking temperature can be increased/decreased in accordance with the user preferences or with the cooking profiles recorded in the memory of the control unit (6), or can be automatically increased/decreased in accordance with the data received from the sensors (12). The mixer motor (10) speed is increased/decreased via the user interface (13). The microprocessor (not shown in the figures) of the cooktop (16) detects the operating parameters entered via the user interface (13), for example the temperature or the mixer motor (10) speed settings, as well as the sensor (12) data by means of the communication means (14), adjusts the induction coil (17) power and enables the appliance (1) to be operated on the cooktop (16) at the desired power level. The power adjustment button on the cooktop (16) is used for only the initial energizing of the appliance (1). Temperature and the mixer motor (10) speed settings are adjusted via the user interface (13), in other words the appliance (1) controls the cooktop (16) in accordance with the operating parameters entered via the user interface (13).

In an embodiment of the present invention, the cooking pot (4) and the lid (5) are produced from a non-conductive and heat-resistant material (glass, ceramic, porcelain, etc.). The base (2) produced from a magnetic material is integrated with the bottom of the cooking pot (4).

In another embodiment of the present invention, the appliance (1) comprises two receiver coils (3), one providing electrical power for the mixer motor (10), and the other providing electrical power for the control unit (6), the communication means (14) and the user interface (13) through the voltage regulating circuit (15).

The appliance (1) communicates with the cooktop (16) in order to provide the temperature required by the user, can change the temperature/power setting of the cooktop (16), can maintain the required temperature or apply a temperature profile. At the end of the cooking process, the heating is cut off or the cooktop (16) is turned off. The mixer motor (10) on the appliance (1) can be operated at more than one speed setting. The mixer motor (10) can be operated at the speed in accordance with the user preferences. Cutting, chopping or mixing processes can be performed before the cooking, during the cooking or after the cooking.

Via the user interface (13), cooking/mixing duration data can be entered to the appliance (1) besides the temperature, the mixer motor (10) speed data, and a selection can be made from the food recipes in the menu shown in the display or new food recipes can be entered. According to the recipe already available in the memory of the control unit (6) or that is newly entered, the chopping, cooking and mixing processes can be performed step by step. At the end of the cooking process, audio or visual alerts are given and for a period of time adjusted by the user, the food can be kept hot. In accordance with the user preferences, the cooking process can be delayed and started at a time selected via the user interface (13).

In another embodiment of the present invention, the appliance (1) comprises a separator (18) placed between the cooking pot (4) and the lid (5) (FIG. 3). The separator (18) protects the control unit (6) and other electronic components in the lid (5) against the liquids splattered by the foods being cooked and against the vapor.

The separator (18) comprises a side centering hole (19) that aligns the socket (8) and the plug (9) to enable them to be easily joined and a medial centering hole (20) that aligns the mixer motor (10) shaft and the mixing or chopping apparatus (11) to enable them to be easily joined while the lid (5) is being placed onto the cooking pot (4).

In another embodiment of the present invention, the appliance (1) comprises an opening (21) arranged on the lid (5) and an exhaust apparatus (22) that is situated on the separator (18), that extends towards the upper side of the lid (5) through the opening (21) when the lid (5) is placed onto the cooking pot (4), that provides vapor discharge from the cooking pot (4), that provides the monitoring of the foods being cooked and also allows materials such as salt, spices, etc. to be added during the cooking process.

In an embodiment of the present invention, the appliance (1) is operated on a cooktop (16) without any communication infrastructure, no communication means (14) is used and the heating power is not adjusted via the user interface (13). The heating setting of the appliance (1) is made by means of the power adjustment button (not shown in the figures) on the cooktop (16).

In the appliance (1) of the present invention, the energy required for heating processes such as cooking, keeping warm, etc. is supplied from the induction coil (17) via the ferromagnetic base (2). The energy required for the mixer motor (10), the control unit (6), the user interface (13) and the communication means (14) is supplied from the induction (17) of the cooktop (16) via the receiver coil (3) and is transmitted to the lid (5) by means of the connector (7). The lid (5) serves as a detachable electronic module that provides the adjustment, monitoring and controlling of all parameters such as cooking temperature, cooking duration, the mixer motor (10) speed, etc. and as well as communication with the cooktop (16). Since the mixer motor (10), the control unit (6), the voltage regulating circuit (15), the user interface (13) and the communication means (14) are situated on the lid (5), a cooking pot (4) with a simple configuration can be used and the cooking pot (4) can be detached from the lid (5) and easily cleaned. The appliance (1) adjusts the heating power transferred from the cooktop (16) and the mixer motor (10) operating power according to the data received from the sensors (12) and the settings entered via the user interface (13), performs the cooking process at the desired temperature and mixes the food during cooking.

It is to be understood that the present invention is not limited by the embodiments disclosed above and a person skilled in the art can easily introduce different embodiments. These should be considered within the scope of the protection postulated by the claims of the present invention.

1. An appliance (1) suitable to be operated wirelessly on a cooktop (16) having one or more than one induction coil (17), comprising a ferromagnetic base (2) enabling the appliance (1) to be heated with the magnetic energy transmitted by the induction coil (17), one or more than one receiver coil (3) integrated with the base (2), that partially receives the power generated by the induction coil (17), a cooking pot (4) wherein food cooking and/or mixing operations are performed, a hollow lid (5) that is closed over the cooking pot (4) and a control unit (6) that provides the controlling of parameters such as the cooking temperature, cooking duration, mixing speed, etc., characterized in that the control unit (6) encapsulated by the lid (5) and one or more than one connector (7) that provides energy transmission from the receiver coil (3) to the control unit (6) when the lid (5) is placed onto the cooking pot (4).

2. An appliance (1) as in claim 1, characterized in that the connector (7) comprising a socket (8) that is situated on the lid (5) and connected to the control unit (6) and a plug (9) that is situated on the cooking pot (4) and connected to the receiver coil (3).

3. An appliance (1) as in claim 1, characterized in that the connector (7) comprising the socket (8) situated at the lower edge of the lid (5) and the plug (9) situated at the upper edge of the cooking pot (4).

4. An appliance (1) as in claim 1, characterized in that a mixer motor (10) that is situated inside the lid (5), that is connected to the control unit (6), to which electrical power is transmitted from the receiver coil (3) by means of the connector (7) and in that a mixing or chopping apparatus (11) connected to the mixer motor (10).

5. An appliance (1) as in claim 4, characterized in that the variable speed mixer motor (10).

6. An appliance (1) as in claim 1, characterized in that one or more than one sensor (12) placed at the cooking pot (4) and detecting parameters such as temperature, level, overflowing, saltiness, etc. and in that the connector (7) that provides the sensor (12) signals to be transmitted to the control unit (6).

7. An appliance (1) as in claim 1, characterized in that a user interface (13) that is situated on the lid (5), that is connected to the control unit (6), that receives electrical power from the receiver coil (3) by means of the connector (7) and that has a display and a keypad that provide the monitoring and controlling of the operating parameters.

8. An appliance (1) as in claim 1, characterized in that one or more than one communication means (14) that is situated inside or on the lid (5), that is connected to the control unit (6), that receives electrical power from the receiver coil (3) by means of the connector (7) and that provides communication with the cooktop (16).

9. An appliance (1) as in claim 1, characterized in that a voltage regulating circuit (15) that is situated in the lid (5), that enables the control unit (6), the user interface (13) and the communication means (14) to be supplied with a constant, uninterrupted DC voltage with the power partially received from the induction coil (17) by the receiver coil (3).

10. An appliance (1) as in claim 1, characterized in that the cooking pot (4) and the lid (5) produced from a non-conductive and heat-resistant material.

11. An appliance (1) as in claim 1, characterized in that two receiver coils (3), one providing electrical power for the mixer motor (10), and the other providing electrical power for the control unit (6), the communication means (14) and the user interface (13).

12. An appliance (1) as in claim 1, characterized in that a separator (18) that is placed between the cooking pot (4) and the lid (5).

13. An appliance (1) as in claim 12, characterized in that the separator (18) that has a side centering hole (19) enabling the socket (8) and the plug (9) to be joined and a medial centering hole (20) that enables the mixer motor (10) shaft and the mixing or chopping apparatus (11) to be joined.

14. An appliance (1) as in claim 12, characterized in that an opening (21) arranged on the lid (5) and an exhaust apparatus (22) that is situated on the separator (18), that extends towards the upper side of the lid (5) through the opening (21) and that provides vapor discharge from the cooking pot (4).

15. An appliance (1) as in claim 1, that is operated on a cooktop (16) without communication infrastructure, and the heating adjustment of which is realized by means of a power adjustment button on the cooktop (16).
